(19) United States
(12) Patent Application Publication
(10) Pub. No.: US 2006/0130975 A1
(43) Pub. Date: Jun. 22, 2006

(54) Thermal activation apparatus and printer including the same

(76) Inventors: Masanori Takahashi, Chiba-shi (JP); Minoru Hoshino, Chiba-shi (JP); Yoshinori Sato, Chiba-shi (JP); Hiroyuki Kohira, Chiba-shi (JP); Tatsuya Obuchi, Chiba-shi (JP)

Correspondence Address: ADAMS & WILKS, 17 BATTERY PLACE, SUITE 1231, NEW YORK, NY, 10004, US

(21) Appl. No.: 11/288,737

(22) Filed: Nov. 29, 2005

(30) Foreign Application Priority Data
Dec. 16, 2004 (JP) 2004-364002

(51) Int. Cl. B32B 37/00

(52) U.S. Cl. 156/384; 156/538

(57) ABSTRACT

Provided is a thermal activation apparatus in which a discharge path of a heat-sensitive adhesive label is not adversely affected by adhesive residue. The thermal activation apparatus includes a discharge roller (5) for completely discharging a heat-sensitive adhesive label with its heat-sensitive adhesive agent layer formed on the back side that is heated by a thermal head from between the thermal head and a platen roller. Grooves (53) are formed along the circumferential direction of the discharge roller 5 at places which correspond to the lateral edges of various kinds of heat-sensitive adhesive labels.

### BACKGROUND OF THE INVENTION

1. Field of the Invention

The present invention relates to a thermal activation apparatus for transporting a sheet material having a thermally activated adhesive surface formed on one side thereof, which becomes adhesive when heated, and for heating the thermally activated adhesive surface of the sheet material, and to a printer including the same.

2. Description of the Related Art

These days, an adhesive label for a bar code, a price tag, or the like which often has an adhesive agent layer formed on the back side of a recording surface (printing surface), is stored with backing paper or a release liner stuck thereon to temporarily adhere the adhesive to the backing paper or the release liner. However, this type of an adhesive label is inconvenient because it is necessary to peel off the release liner from the adhesive agent layer when the label is used and waste is inevitably generated.

For this reason, as a system where no release liner is required, a heat-sensitive adhesive label having a heat-sensitive adhesive agent layer formed on the back side of a sheet-like substrate which, under normal conditions, does not exhibit adhesion, but when heated, generates adhesion, and a thermal activation apparatus for heating the heat-sensitive adhesive agent layer formed on the back side of the label to generate its adhesion have been developed.

For example, as the above-mentioned thermal activation apparatus, an apparatus using as heating means various kinds of heating system such as a heat roll system, a hot air spray system, an infrared radiation system, and a system using an electric heater or a dielectric coil have been proposed. Further, JP 11-79152 A discloses technology where a thermal activation head having as heat sources a plurality of resistors (heating elements) provided on a ceramic substrate comes in contact with a heat-sensitive adhesive label to heat the heat-sensitive adhesive agent layer, for example, a thermal head used as a print head of a thermal printer.

The structure of such a thermal activation apparatus will be described using an example of a system having a thermal activation head which is disclosed in JP 11-79152 A. FIG. 3 is a schematic sectional view illustrating an exemplary structure of a conventional thermal activation apparatus.

A heat-sensitive adhesive label 1 used in the thermal activation apparatus illustrated in FIG. 3 has a structure where, for example, a printable layer is formed on a front side of a sheet-like substrate while a heat-sensitive adhesive agent layer formed by applying and drying a heat-sensitive adhesive is formed on a back side of the sheet-like substrate.

The thermal activation apparatus includes a thermal head 2 having heating elements for heating the heat-sensitive adhesive agent layer formed on the back side of the heat-sensitive adhesive label 1, a platen roller 3 for transporting the heat-sensitive adhesive label 1 with the heating elements of the thermal head 2 in contact with the heat-sensitive adhesive label 1, insert rollers 4 for inserting the heat-sensitive adhesive label 1 between the thermal head 2 and the platen roller 3, and a discharge roller 5 for completely discharging the heat-sensitive adhesive label 1 with its heat-sensitive adhesive agent layer formed on the back side heated by the thermal head 2 from between the thermal head 2 and the platen roller 3. Further, a catching portion 6 for catching a trailing edge of the heat-sensitive adhesive label 1 which droops under its own weight is provided over the discharge roller 5 to prevent the heat-sensitive adhesive label 1 with the adhesion of its heat-sensitive adhesive agent layer formed on the back side generated from dropping from the thermal activation apparatus and sticking to a desk or the like when it is completely discharged from between the thermal head 2 and the platen roller 3 is provided.

The reason that the above-described thermal activation apparatus is provided with the discharge roller 5 is, if the trailing edge of the heat-sensitive adhesive label 1 remains between the thermal head 2 and the platen roller 3 when heating of the heat-sensitive adhesive agent layer of the heat-sensitive adhesive label 1 is completed, the heat-sensitive adhesive label 1 may stick to the thermal head 2, or, when the surface of the heat-sensitive adhesive label 1 is a heat-sensitive printing layer, the printing surface may be colored by residual heat, and thus, it is necessary for the heat-sensitive adhesive label 1 to be completely discharged by the discharge roller 5 from between the thermal head 2 and the platen roller 3.

A rubber roller is used as the discharge roller 5. Since the discharge roller 5 is a portion that comes in contact with the adhesive surface of the heat-sensitive adhesive label, a roller made of a nonadhesive material such as fluoroplastic is used so that the adhesive surface is smoothly separated from the discharge roller 5 without sticking to the discharge roller 5 when the label is discharged.

However, even in the conventional case of the discharge roller where a material such as fluoroplastic to which an adhesive is difficult to stick is used as the roller material, once adhesive residue adheres to the perimeter of the roller, and since additional residue accumulates on the attached residue, the discharge path of the heat-sensitive adhesive label may be clogged in the course of time, which adversely affects discharge of the heat-sensitive adhesive label.

Most of the adhesive residue which sticks onto the roller as described above sticks to places corresponding to the vicinity of lateral edges of the heat-sensitive adhesive label (the vicinity of edges in a direction orthogonal to the label transport direction). FIG. 4 illustrates the structure of the discharge roller of FIG. 3 and shows places where residue accumulates on the discharge roller when three kinds of heat-sensitive adhesive labels having different paper widths are discharged. As illustrated in FIG. 4 by diagonally shaded areas, an adhesive residue accumulates on the discharge roller correspondingly to the vicinity of lateral edges of the respective heat-sensitive adhesive labels.

The reason that the adhesive residue tends to accumulate easily on the discharge roller correspondingly to the vicinity of the lateral edges of heat-sensitive adhesive labels is thought to be that, since the heating elements of the thermal head are arranged laterally with respect to the heat-sensitive adhesive label, when the back side of the heat-sensitive adhesive label is heated by the thermal head, heat on the label is not diffused in the lateral direction of the label in the vicinity of the lateral edges of the heat-sensitive adhesive label, the heat rather accumulates and raises the temperature, and the viscosity of the heat-sensitive adhesive in the vicinity of the lateral edges of the heat-sensitive adhesive label becomes too low, which makes the heat-sensitive adhesive in the vicinity more likely to stick to the roller. Further, the heat-sensitive adhesive label heated by the thermal head is sometimes curled such that the lateral center thereof rises slightly with respect to the vicinity of the edges, and as a result, contact pressure on the roller in the vicinity of the lateral edges of the heat-sensitive adhesive label is thought to become higher than that on other portions on the roller, which makes the heat-sensitive adhesive in the vicinity more likely to stick to the roller.

### SUMMARY OF THE INVENTION

Accordingly, the present invention has been made in view of the above-described problem of the prior art. An object of the present invention is to provide a thermal activation apparatus including a discharge roller to which adhesive residue is less likely to stick, and to provide a printer including the same.

In order to achieve the aforementioned object, according to one aspect of the present invention, a thermal activation apparatus includes: a heating head for heating a heat-sensitive adhesive agent layer formed on one side of a heat-sensitive adhesive label; and a discharge roller for discharging the heat-sensitive adhesive label in contact with the heat-sensitive adhesive agent layer exhibiting adhesion after being heated by the heating head. In the thermal activation apparatus, grooves are formed around the discharge roller at places corresponding to lateral edges of the heat-sensitive adhesive label.

According to the present invention described above, since places on the discharge roller, which correspond to the lateral edges of the heat-sensitive adhesive label are grooves, the vicinity of the lateral edges of the heat-sensitive adhesive label does not come into contact with the discharge roller, and thus, there is no fear that adhesive residue accumulates on the discharge roller to adversely affect the discharge path as in the prior art.

According to another aspect of the present invention, a thermal activation apparatus includes: a heating head for heating a heat-sensitive adhesive agent layer formed on one side of a heat-sensitive adhesive label; and a discharge roller for discharging the heat-sensitive adhesive label in contact with the heat-sensitive adhesive agent layer exhibiting adhesion after being heated by the heating head. In the thermal activation apparatus, the discharge roller includes a shaft and a plurality of O rings fitted onto the shaft, the O rings not being arranged on places corresponding to lateral edges of the heat-sensitive adhesive label.

According to the present invention described above, since the discharge roller has a plurality of O rings arranged on a shaft thereof, the contact area of the discharge roller with the heat-sensitive adhesive label becomes smaller. As a result, the heat-sensitive adhesive label is made less likely to stick to the discharge roller. In addition, since the O rings are not arranged on places corresponding to the lateral edges of the heat-sensitive adhesive label, the vicinity of the lateral edges of the heat-sensitive adhesive label can find nothing to stick to, and thus, there is no fear that the adhesive residue may accumulate on the discharge roller to adversely affect the discharge path as in the prior art.

Further, the present invention can also provide a printer including the above thermal activation apparatus and a print head provided upstream to the thermal activation apparatus in a heat-sensitive adhesive label transport direction for printing on the surface of the heat-sensitive adhesive label.

According to the present invention described above, since adhesive residue on the back side of a heat-sensitive adhesive label does not accumulate on the discharge roller for the label, the discharge path of the heat-sensitive adhesive label is not adversely affected.

### BRIEF DESCRIPTION OF THE DRAWINGS

In the accompanying drawings:

FIG. 1 is a plan view for explaining the structure of a discharge roller according to a first embodiment of the present invention;

FIG. 2 is a plan view for explaining the structure of a discharge roller according to a second embodiment of the present invention;

FIG. 3 is a schematic sectional view illustrating an exemplary structure of a conventional thermal activation apparatus; and

FIG. 4 is a view for explaining a problem of a discharge roller provided in the thermal activation apparatus of FIG. 3.

### DETAILED DESCRIPTION OF THE PREFERRED EMBODIMENTS

Embodiments of the present invention will be described with reference to the drawings.

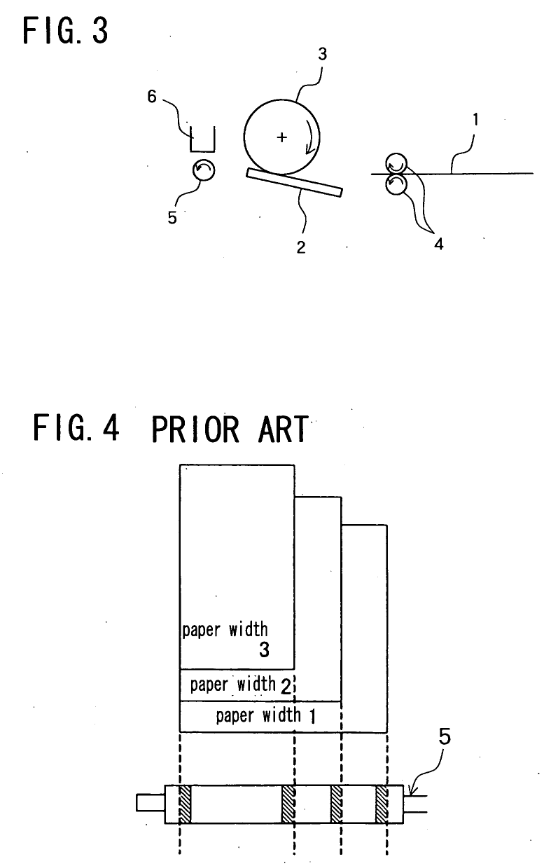

As illustrated in FIG. 3, a thermal activation apparatus of this embodiment includes a thermal head 2 as a heating head having heating elements for heating a heat-sensitive adhesive agent layer formed on the back side of a heat-sensitive adhesive label 1, a platen roller 3 for transporting the heat-sensitive adhesive label 1 with the heating elements of the thermal head 2 in contact with the heat-sensitive adhesive label 1, insert rollers 4 for inserting the heat-sensitive adhesive label 1 between the thermal head 2 and the platen roller 3, and a discharge roller 5 for completely discharging from between the thermal head 2 and the platen roller 3, the heat-sensitive adhesive label 1 with its heat-sensitive adhesive agent layer formed on the back side heated by the thermal head 2.

Further, a catching portion 6 for catching a trailing edge of the heat-sensitive adhesive label 1 which droops under its own weight is provided over the discharge roller 5 to prevent the heat-sensitive adhesive label 1 with the adhesion of its heat-sensitive adhesive agent layer formed on the back side generated from dropping from the thermal activation apparatus and sticking to a desk or the like when it is completely discharged from between the thermal head 2 and the platen roller 3.

As the thermal head 2, a thermal head structured similarly to a known print head for a thermal printer is used in which a protective film of crystallized glass is provided on the surface of a plurality of heater resistors formed on a ceramic substrate by thin film technology.

The platen roller 3 is provided with a drive system including, for example, a stepping motor and a gear train. The platen roller 3 is rotated by the drive system to transport the heat-sensitive adhesive label 1 in a predetermined direction (to the left in FIG. 3). Further, the thermal activation apparatus is also provided with pressure means (for example, a coil spring or a leaf spring) for pressing the platen roller 3 against the thermal head 2. Here, by maintaining the rotation axis of the platen roller 3 and the direction of arrangement of the heating elements of the thermal head 2 in parallel with each other, the platen roller 3 can be pressed uniformly over the whole width of the heat-sensitive adhesive label 1.

When the thermal activation apparatus of this embodiment is applied to a printer for a heat-sensitive adhesive label, print means such as a thermal head or an inkjet head which can print on a printable layer on the surface of the heat-sensitive adhesive label 1 is provided upstream to the insert rollers 4 in the label transport direction. The heat-sensitive adhesive label 1 may be a sheet or roll paper. When the heat-sensitive adhesive label 1 is roll paper, it is cut to a predetermined length after printing, and then inserted between the thermal head 2 and the platen roller 3 by the insert rollers 4.

The embodiment of the thermal activation apparatus described in the above is different from the thermal activation apparatus of FIG. 3 in the shape of the discharge roller 5 for completely discharging the heat-sensitive adhesive label 1 from between the thermal head 2 and the platen roller 3. The structure of the discharge roller 5 is described hereinafter.

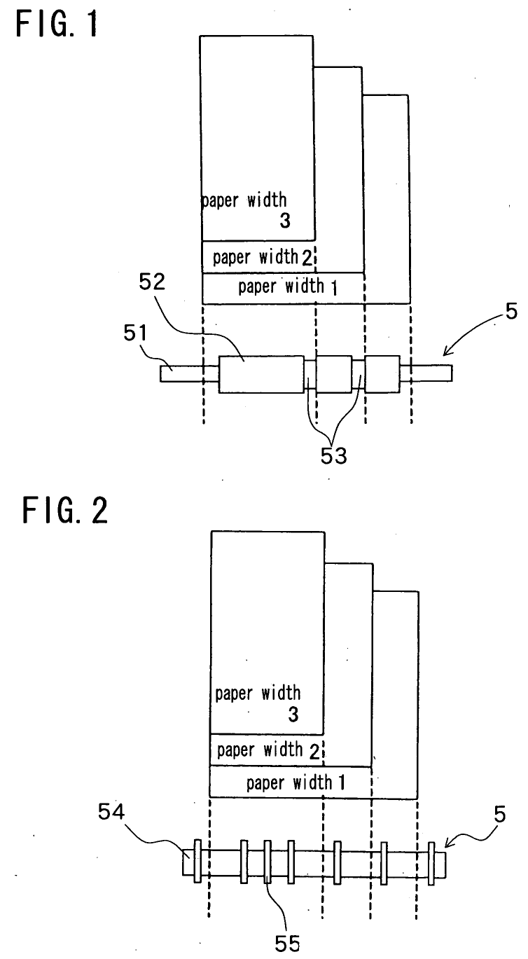

FIG. 1 is a plan view for explaining the structure of the discharge roller according to a first embodiment of the present invention. It is to be noted that FIG. 1 illustrates discharge of three different kinds of heat-sensitive adhesive labels having different paper width.

As illustrated in FIG. 1, the discharge roller of this embodiment is provided with a roller 52 on a shaft 51. Rubber, resin, or the like is used for the roller 52. The width of the roller 52 corresponds to the width of a heat-sensitive adhesive label to be discharged having the maximum paper width. It is preferable that the material used for the roller 52 is a nonadhesive material so that adhesive on the back side of the heat-sensitive adhesive label does not stick thereto.

Grooves 53 formed along the circumferential direction of the discharge roller 5 at places which correspond to the lateral edges of various kinds of heat-sensitive adhesive labels. In this embodiment, the places of the roller 52 where the grooves 53 are formed correspond to lateral ends of heat-sensitive adhesive labels having relatively frequently used three kinds of paper widths. It is to be noted that the number of such places is not limited.

When heat-sensitive adhesive labels having various kinds of paper widths are discharged by the discharge roller 5, since the vicinity of the lateral edges of the heat-sensitive adhesive labels does not come in contact with the discharge roller 5, adhesive residue on the back side of the heat-sensitive adhesive label does not accumulate on the discharge roller 5 as in the prior art, and thus, there is no fear that the discharge path is adversely affected.

FIG. 2 is a plan view for explaining the structure of a discharge roller according to a second embodiment of the present invention. This figure also illustrates discharge of three different kinds of heat-sensitive adhesive labels having different paper width.

The discharge roller of the embodiment illustrated in FIG. 2 is different from that illustrated in FIG. 1, and includes a shaft 54 and a plurality of O rings 55 fitted onto the shaft 54. It is preferable that a nonadhesive resin is used for the O rings 55.

In this discharge roller, the O rings 55 are not arranged on places corresponding to the lateral edges of the heat-sensitive adhesive labels having the three different paper width. It is to be noted that the places where the O rings 55 are not arranged correspond to lateral ends of heat-sensitive adhesive labels having relatively frequently used three kinds of paper width, and the number of places where the O rings 55 are not arranged is not limited.

When heat-sensitive adhesive labels having various kinds of paper width are discharged by the discharge roller 5 of FIG. 2, since the discharge roller 5 is structured such that the plurality of O rings 55 are arranged on the shaft 54, the contact area of the discharge roller 5 with the heat-sensitive adhesive labels becomes smaller. As a result, the heat-sensitive adhesive labels are made less likely to stick to the discharge roller 5. In addition, since the O rings 55 are not arranged on places corresponding to the lateral edges of the heat-sensitive adhesive label, the vicinity of the lateral edges of the heat-sensitive adhesive label can find nothing to stick to, and thus, there is no fear that adhesive residue on the back side of the heat-sensitive adhesive label accumulates on the discharge roller 5 to adversely affect the discharge path as in the prior art.

What is claimed is:

1. A thermal activation apparatus, comprising:
a heating head for heating a heat-sensitive adhesive agent layer formed on one side of a heat-sensitive adhesive label; and
a discharge roller for discharging the heat-sensitive adhesive label in contact with the heat-sensitive adhesive agent layer exhibiting adhesion after being heated by the heating head,
wherein grooves are formed around the discharge roller at places corresponding to lateral edges of the heat-sensitive adhesive label.

2. A thermal activation apparatus, comprising:
a heating head for heating a heat-sensitive adhesive agent layer formed on one side of a heat-sensitive adhesive label; and
a discharge roller for discharging the heat-sensitive adhesive label in contact with the heat-sensitive adhesive agent layer exhibiting adhesion after being heated by the heating head,
wherein the discharge roller comprises a shaft and a plurality of O rings fitted onto the shaft, the O rings not being arranged on places corresponding to lateral edges of the heat-sensitive adhesive label.

3. A thermal activation apparatus according to claim 2, wherein the O rings are made of a nonadhesive material.

4. A printer, comprising:
the thermal activation apparatus according to claim 3; and
a print head provided upstream to the thermal activation apparatus in a heat-sensitive adhesive label transport direction for printing on the other side of the heat-sensitive adhesive label.

5. A printer, comprising:
the thermal activation apparatus according to claim 2; and
a print head provided upstream to the thermal activation apparatus in a heat-sensitive adhesive label transport direction for printing on the other side of the heat-sensitive adhesive label.

6. A printer, comprising:
the thermal activation apparatus according to claim 1; and
a print head provided upstream to the thermal activation apparatus in a heat-sensitive adhesive label transport direction for printing on the other side of the heat-sensitive adhesive label.
